(19) United States
(12) Patent Application Publication
(10) Pub. No.: US 2005/0201054 A1
(43) Pub. Date: Sep. 15, 2005

(54) Coupler for mounting a device to another device, and related system and method

(76) Inventors: John Norman, San Jose, CA (US); Thomas S. Neal, Cupertino, CA (US); Guillermo Andres, Pleasanton, CA (US); Ray Gradwohl, Saratoga, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/800,279

(22) Filed: Mar. 12, 2004

(51) Int. Cl. G06F 1/16

(52) U.S. Cl. 361/686

(57) ABSTRACT

A coupler for releasably mounting a computer peripheral device to another device includes a first portion operable to engage the computer peripheral device, and a second portion operable to engage the other device. Or, a computer peripheral device includes a connector for mounting the computer peripheral device to another device. With the coupler, the computer peripheral device may more securely support the other device as compared to one placing the other device on top of the computer peripheral device. Similarly, with the connector, the computer peripheral device may more securely support the other device. Furthermore, with the coupler, connector, or both, one may generate a stack including three or more peripheral devices of a computer system by mounting each additional device to an adjacent device in the stack. Thus, a housing of the computer system may support more peripheral devices.

### BACKGROUND

Many computer systems include processing circuitry for performing various computer functions such as receiving and generating data and executing programs to perform specific tasks. These computer systems also often include one or more peripheral devices that the processing circuitry may read data from, write data to, or otherwise control to enhance and/or expand the function of the processing circuitry. Examples of peripheral devices include a wireless receiver to allow the processing circuitry to read data generated by a mouse and/or keyboard, a wireless transmitter to allow the circuitry to write data to a printer and/or a personal data assistant, a memory card reader to allow the circuitry to read data from a portable memory card, and a connector module, such as a network hub, to allow the processing circuitry to communicate with another computer system.

FIG. 1 is a perspective view of a computer system 10 that includes a housing 12 for protecting the processing circuitry (not shown) disposed inside the housing, and two peripheral devices 14 and 16 (here a memory card reader and a wireless receiver). Cables 18 and 20 couple the reader 14 and receiver 16, respectively, to an interface 22 so that the processing circuitry can read data from the devices. Each peripheral device 14 and 16 is typically placed on top of the housing 12 or some other surface (not shown) located close to the interface 22 when coupled to the interface to reduce the length of the cables 18 and 20. By reducing the length of the cables, one can reduce the risk that the cables will get snagged, by one's arm or some other item, and pulled, which can damage the devices, interface, cables and/or processing circuitry.

Unfortunately, locating more than two peripheral devices on top of the housing 12 can be problematic. The area on top of the housing 12 is often limited. Because each peripheral device is typically placed directly on the housing 12, the number of peripheral devices one can set on the housing is often limited to two. Furthermore, the cables 18 and 20 coupling the devices to the interface 22 occupy a portion of the area on top of the housing 12 and, thus, further reduce the area available to support additional devices.

Stacking the peripheral devices 14 and 16 on top of each other may be a solution to this problem, but stacking the devices can also be problematic. Stacking the devices 14 and 16 typically includes placing a first device on the housing, and then placing a second device on the first device. If a third device is included in the system, the additional device may be placed on top of the second device, and so on for additional devices. Unfortunately, when the devices are stacked on top of each other, one can accidentally contact and knock the devices above the first device, and especially the top device, off the stack with one's arm, hand or some other object and, thus, damage the device, the other devices in the stack, the cables and/or the interface 22.

### SUMMARY

In one aspect of the invention, a coupler for releasably mounting a computer peripheral device to another device includes a first portion operable to engage the computer peripheral device, and a second portion operable to engage the other device. In another aspect of the invention, a computer peripheral device includes a connector operable to mount the computer peripheral device to another device. With the coupler, the computer peripheral device may more securely support the other device as compared to one placing the other device on top of the computer peripheral device as discussed in the background section. Similarly, with the connector, the computer peripheral device may more securely support the other device. Furthermore, with the coupler, connector, or both, one may generate a stack including three or more peripheral devices of a computer system by mounting each additional device to an adjacent device in the stack. Thus, a housing of the computer system may support more peripheral devices.

### BRIEF DESCRIPTION OF THE FIGURES

FIG. 1 is a perspective view of a computer system including two peripheral devices, each placed on top of a housing of the system.

FIG. 2 is a perspective view of a computer system incorporating a coupler that mounts a peripheral device to another peripheral device according to an embodiment of the invention.

FIG. 3 is an exploded, perspective view of the coupler and peripheral devices in FIG. 2 according to an embodiment of the invention.

FIG. 4 is an exploded, perspective view of two peripheral devices, one of which incorporates a connector according to another embodiment of the invention.

### DETAILED DESCRIPTION

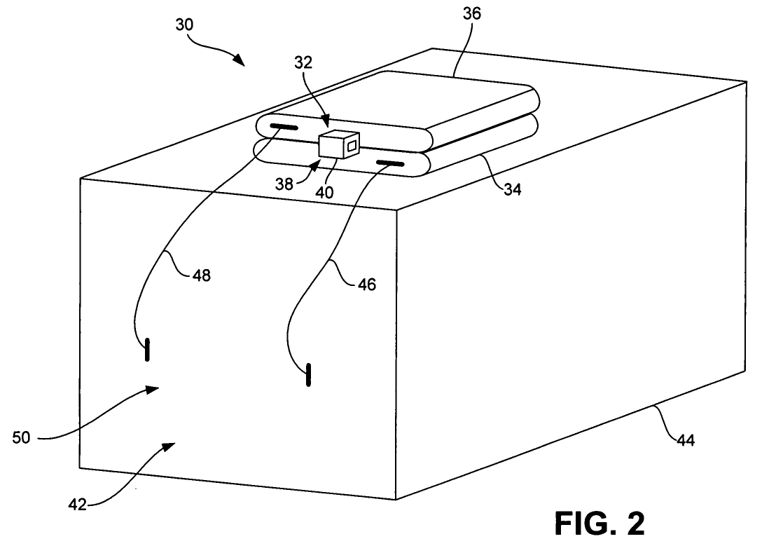

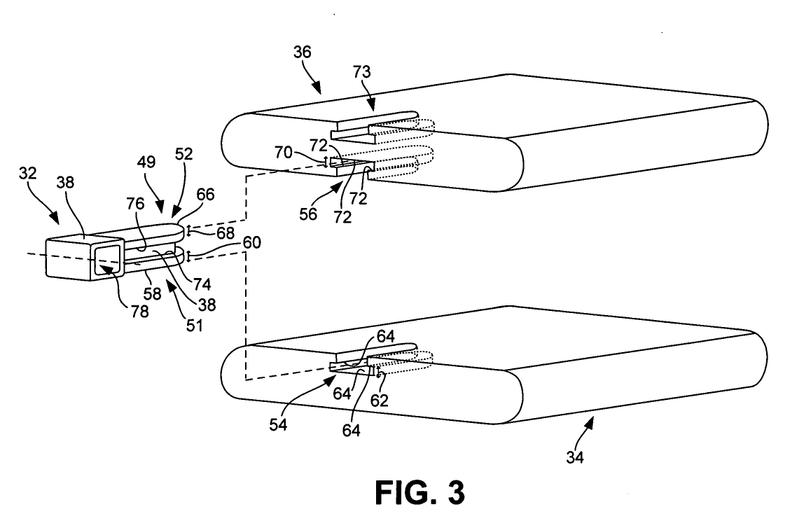

FIG. 2 is a perspective view of a computer system 30 incorporating a coupler 32 according to an embodiment of the invention. The coupler 32 releasably mounts a first peripheral device 34, for example a wireless receiver, to a second peripheral device 36, for example a memory card reader, and includes a body 38 (discussed in greater detail in conjunction with FIG. 3), and a coupling element (not shown but discussed in greater detail in conjunction with FIG. 3). The coupling element releasably fastens the body 38 to the first peripheral device 34 and to the second peripheral device 36 to mount the second device to the first device. The body 38 may include a handle 40 (discussed in greater detail in conjunction with FIG. 3) for grasping the coupler 32 to release the coupling element from the first peripheral device 34 or the second peripheral device 36, and thus dismount the second device from the first device.

The computer system 30 also includes processing circuitry (not shown) for performing various computer functions such as receiving and generating data and executing programs to perform specific tasks, and a housing 44 to protect the circuitry disposed in the housing. Two cables 46 and 48 couple the first and second peripheral devices 34 and 36, respectively, to an interface 50 so that the processing circuitry can read data from, write data to, and otherwise control the devices.

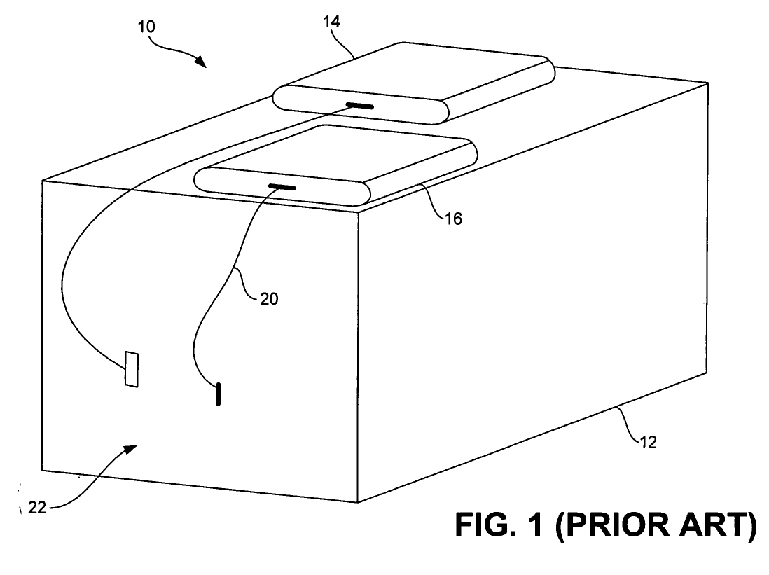

With the coupler 32, one may releasably mount the second device 36 to the first device 34 to more securely support the second device with the first device, as compared to placing the second device on the first device as discussed above in conjunction with FIG. 1. Furthermore, with an additional coupler (not shown), one may mount another peripheral device (not shown) to the second device 36. Consequently, the area of the computer system's housing 44 that is occupied by the peripheral devices 34 and 36, and the additional device, is the same as the area occupied by the first device 34. Thus, the housing 44 may support more peripheral devices.

Other embodiments are contemplated. For example, two or more couplers 32 may mount the second device 36 to the first device 34. In another example, a coupler 32 may mount the first device 34 to the computer system's housing 44. This may be desirable to more securely support the first device 34 with the housing 44, and thus further reduce the risk that the first and second devices will be knocked off the housing and damaged. In yet another example, Velcro® (not shown) may mount the second device 36 to the first device 34. In yet another example, a clamp (not shown) may mount the second device 36 to the first device 34 by wrapping around the first and second devices.

FIG. 3 is an exploded perspective view of the coupler 32, and the peripheral devices 34 and 36 in FIG. 2.

The coupler 32 includes a body 38, and coupling element 52 to releasably fasten the body to the peripheral devices 34 and 36. In one embodiment, the coupling element 52 includes a first portion 49 which may be inserted into a connector 54 (here a receptacle) of the first device 34, and a second portion 51 which may be inserted into a connector 56 (here a receptacle) of the second device 36 to releasably fasten the body 38 to the devices. The coupling element 52 may include a first flange 58 that has a thickness 60 slightly larger than the height 62 of the receptacle 54, and is sized to be insertable into the receptacle. With the first flange's thickness 60 slightly larger than the receptacle's height 62, the first flange 58 may be wedged into the receptacle 54 to releasably fasten the first device 34 to the body 38. Thus, friction between the first flange 58 and the receptacle's walls 64 can secure the first device 34 to the coupler 32. Likewise, the coupling element 52 may include a second flange 66 that has a thickness 68 slightly larger than the height 70 of the receptacle 56, and is sized to be insertable into the receptacle. Furthermore, the second flange 66 may be wedged into the receptacle 56 to releasably fasten the second device 36 to the body 38, and thus friction between the second flange 66 and the receptacle's walls 72 can secure the second device to the coupler 32.

Other embodiments are contemplated. For example, the coupling element 52 may include a receptacle sized to receive a flange (not shown) of the device 54 or 56. In another example, the coupling element 52 may include a hook (not shown) insertable into a cavity of a receptacle (not shown) of the device 54 or 56 to secure the device to the coupler 32. In yet another example, the coupling element 52 may be inserted into a receptacle (not shown) of the device 54 or 56 and secured to a device with Velcro®.

Still referring to FIG. 3, in operation, one may mount the second device 36 to the first device 34 by releasably fastening the first device to the coupler 32 and releasably fastening the second device 36 to the coupler. In one embodiment (assuming the coupler 32 is not fastened to the first or second devices 34 and 36), one may first insert the first flange 58 into the first device's receptacle 54 to releasably fasten the device to the coupler 32. Then, one may insert the second flange 66 into the second device's receptacle 56 to releasably fasten the device to the coupler 32. When the devices are mounted together, the devices 34 and 36 may contact each other to help stabilize the mounting of the second device 36 to the first device 34.

Still referring to FIG. 3, the second device 36 includes a second connector 73 (here a receptacle) that can receive another coupler (not shown) to releasably mount a third device (not shown) to the second device. Likewise, the third device may also include a second connector to releasably mount a fourth device with yet another coupler. Thus, the housing 44 (FIG. 2) may support more than two peripheral devices.

Still referring to FIG. 3, the coupler 32 may be made from any desirable material using any desired manufacturing process. For example, in one embodiment the coupler 32 may be made of conventional plastic, such as Acrylonitrile Butadiene Styrene (ABS), and cast as one piece from a mold. Thus, the coupling element 52 and handle 40 may be an integral part of the formed coupler 32. In other embodiments, the coupling element 52 and handle 40 may be fastened to the body 38 using any desired means, such as gluing with an adhesive.

Still referring to FIG. 3, the coupling element 52 may be shaped as desired to releasably fasten the body 38 to the first device 34 and the second device 36. For example, in one embodiment, the first flange 58 extends from a bottom 74 of the body 38 and substantially perpendicular (90°) to the body. And the second flange 66 extends from a top 76 of the body 38 and substantially perpendicular to the body 38. Thus, the coupler 32 has a cross-section in the shape of an “I”.

Other embodiments are contemplated. For example, the first and second flanges 58 and 66 may extend from the bottom 74 and top 76, respectively, at angles other than 90°, such as 45° or 60°. In another example, the first and second flanges 58 and 66 may extend from other portions of the body 38, such as the middle. In yet another example, the first flange 58 may include two or more sub-flanges (not shown) each extending from a respective portion of the bottom 74, and the second flange 66 may include two or more sub-flanges (not shown) each extending from a respective portion of the top 76. For example, the first flange 58 may include a sub-flange extending from a portion of the bottom 74 that is located adjacent the handle 40, and another sub-flange extending from a portion of the bottom that is located at an end of the coupler 32 opposite to the handle 40. In such an embodiment, the bottom 74 may include a portion that does not have a sub-flange extending from it. The second flange 66 may be similarly configured.

Still referring to FIG. 3, the body 38 may include the handle 40 for grasping the coupler 32 to insert or remove the coupling element from the first device 34 and second device 36. The handle 40 may be shaped as desired and may include a hole 78 for engaging the coupler 32 with an object, such as one's finger, a screwdriver or a rod with a hook on its end, to help insert and remove the coupling element 52 from the devices 34 and 36. For example, in one embodiment, the handle 40 has a rectangular shape and the hole 78 extends through the handle. By extending through the handle 40, the hole 78 allows one to insert an object through the handle 40 and hook the handle to obtain a secure grip when removing the coupling element 52 from the first device 34 or second device 36.

Other embodiments are contemplated. For example, the handle 40 may include a flange (not shown) that one may hook with one's finger or other object. In another example, the handle 40 may have another shape, such as curvilinear, elliptic, or spherical.

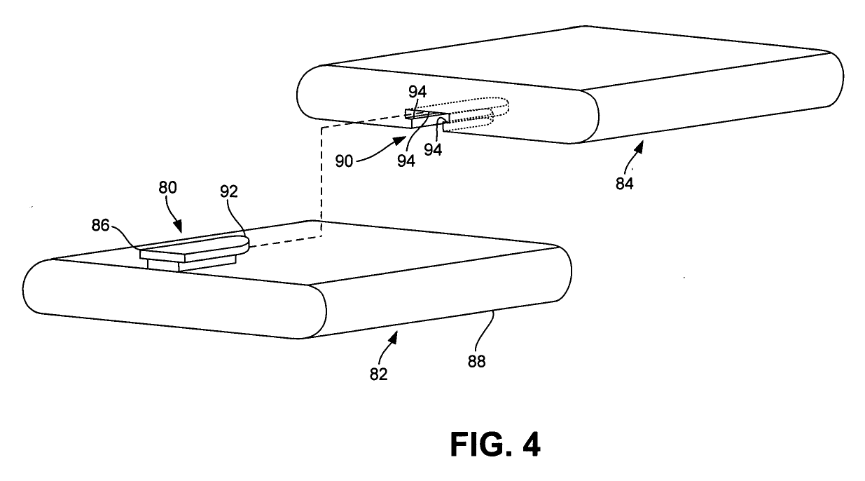

FIG. 4 is an exploded, perspective view of a connector 80 and peripheral devices 82 and 84 according to another embodiment of the invention. In this embodiment, the connector 80 includes a coupling element 86, and the connector and housing 88 of the first device 82 are cast as one piece from a mold. Thus, the coupling element 86 may be an integral part of the formed housing 88. To releasably mount the second device 84 to the first device 82, one inserts the coupling element 86 into the receptacle 90 to wedge the flange 92 between the receptacle's walls 94.

The preceding discussion is presented to enable one skilled in the art to make and use the invention. Various modifications to the disclosed embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

1. A coupler for releasably fastening a computer peripheral device to another device, the coupler comprising:
a first portion operable to engage the computer peripheral device; and
a second portion operable to engage the other device.

2. The coupler of claim 1 wherein the first portion is insertable into a complimentary connector of the computer peripheral device.

3. The coupler of claim 1 wherein the second portion is insertable into a complimentary connector of the other device.

4. A computer peripheral device, comprising a connector operable to mount the computer peripheral device to another device.

5. The device of claim 6 wherein the connector includes a receptacle operable to receive a complimentary portion of a coupler.

6. The device of claim 6 wherein the connector includes a receptacle operable to receive a complimentary connector of the other device.

7. The device of claim 6 wherein the connector includes a coupling element insertable into a complimentary connector of the other device.

8. An electronic system comprising:
a first computer peripheral device; and
a second device releasably mountable to the first device.

9. The system of claim 8 wherein the second device is releasably mountable on top of the first device.

10. The system of claim 8 wherein the second device includes a connector operable to engage a complimentary connector of the first device to releasably mount the second device to the first device.

11. The system of claim 8 further comprising a coupler operable to releasably mount the second device to the first device.

12. The system of claim 8 wherein the second device comprises another computer peripheral device.

13. The system of claim 8 wherein the second device comprises a computer housing.

14. A method for mounting a computer peripheral device to another device, the method comprising:
fastening the computer peripheral device to the other device; and
placing the fastened devices in a desired location.

15. The method of claim 14 wherein placing the devices at a desired location includes placing one of the devices on a housing of a computer system.

16. The method of claim 15 further comprising fastening at least one of the devices to the housing.

17. The method of claim 14 wherein fastening the devices includes:
inserting a first portion of a coupler into a complimentary receptacle of one of the devices, and
inserting a second portion of a coupler into a complimentary receptacle of the remaining device.

18. The method of claim 14 wherein fastening the devices includes inserting a connector of one of the devices into a complimentary connector of the remaining device.
